(19) United States
(12) Patent Application Publication
(10) Pub. No.: US 2023/0064514 A1
(43) Pub. Date: Mar. 2, 2023

(54) CALCINATION APPARATUS AND PROCESS USING HYDROGEN

(71) Applicant: Rio Tinto Alcan International Limited, Montréal (CA)

(72) Inventor: Tomas Mach, Montréal (CA)

(21) Appl. No.: 17/792,576

(22) PCT Filed: Jan. 13, 2021
(86) PCT No.: PCT/IB2021/050198

§ 371 Date: Jul. 13, 2022

(30) Foreign Application Priority Data
Jan. 13, 2020 (AU) 2020900091

(51) Int. Cl. C01F 7/444; B01J 6/00; F27D 7/02

(52) U.S. Cl. CPC C01F 7/444; B01J 6/004; F27D 7/02; C01P 2002/72; F22B 1/003

(57) ABSTRACT

A process of calcining aluminium hydroxide (Al₂O₃.3H₂O) to form alumina (Al₂O₃), for example in an alumina plant, such as a Bayer process plant, is disclosed. The process comprises combusting hydrogen and oxygen and generating steam and heat 5 and using the heat to calcine aluminium hydroxide and form alumina and more steam. An apparatus is also disclosed.

### TECHNICAL FIELD

The present invention relates to a process and an apparatus to calcine aluminium hydroxide to form alumina in an alumina production plant, such as a Bayer process plant.

### BACKGROUND ART

The production of alumina (Al₂O₃) in an alumina production plant, such as a Bayer process plant, includes calcining aluminium hydroxide (Al₂O₃.3H₂O—also termed alumina hydroxide, aluminium trihydrate and hydrated alumina) to remove water.

The calcination of aluminium hydroxide is a thermal decomposition chemical reaction, which proceeds endothermically according to the following reaction:

2Al₂O₃.3H₂O (s)→2Al₂O₃ (s)+3H₂O (g)

A typical calciner used to produce alumina has a reaction chamber that combusts natural gas and oxygen to form heat and flue gas that comprises N₂, CO₂ and steam. The heat generated in the reaction chamber by combustion of natural gas and oxygen is used to drive water off aluminium hydroxide to form alumina. Due to thermal losses during calcination the amount of energy provided to the reaction chamber is significantly more than theoretical requirements. Part of the heat generated in the reaction chamber is transferred to the steam in the flue gas. However, trying to recapture the heat in the flue gas as a way to reduce the amount of energy required for calcination can be technically difficult or cost prohibitive.

The above description is not to be taken as an admission of the common general knowledge in Australia or elsewhere.

### SUMMARY OF THE INVENTION

The applicant operates natural gas-fired calciners to dehydrate aluminium hydroxide in the form of the mineral gibbsite (Al₂O₃.3H₂O) into alumina (Al₂O₃).

The present invention is based on a realization by the inventors that considerable advantages can be realized by calcining aluminium hydroxide in the applicant's calciners by using hydrogen as a combustion fuel either to fully or partially replace natural gas, with the advantage of reducing greenhouse gas emissions associated with the calcination process.

Furthermore, the present invention is based on a realization that the calcination process can be operated beneficially with oxygen, instead of air, to generate a flue gas of pure steam.

The inventors have also realized that the calcination process (combustion of hydrogen and air/oxygen) could be undertaken in a separate reaction chamber to that of current calciners and the steam and heat generated could be used to calcine gibbsite (or other forms of aluminium hydroxide) and form alumina and more steam. The use of a separate reaction chamber has an advantage in terms of retro-fitting current calciners.

Some of the steam discharged from the calciner may be recycled to facilitate fluidization of material, transfer of material and heat. The remainder of the steam may be used elsewhere in the refinery.

In broad terms, the invention provides a process of calcining aluminium hydroxide (Al₂O₃.3H₂O), such as gibbsite, to form alumina (Al₂O₃) for example in an alumina plant, such as a Bayer process plant, the process comprising: supplying hydrogen and oxygen to a reaction chamber and combusting hydrogen and oxygen and generating steam and heat; and using the heat to calcine aluminium hydroxide and form alumina and more steam.

The term “reaction chamber” is understood herein to mean a chamber for calcination reactions of aluminium hydroxide to alumina.

An advantage of combusting hydrogen is that it eliminates the need to use hydrocarbon fuel sources, such as natural gas. As noted above, this can help to reduce carbon-based emissions from the calcination process.

In addition, the process may operate with oxygen only as a source of oxygen and thereby avoid altogether the use of air (i.e. a gas mixture having 78% nitrogen and 21% oxygen). This is an advantage in terms of reducing the gas volumes processed in a plant.

The process may operate with oxygen-enriched air and, depending on the amount of enrichment reduce the amount of nitrogen compared to operating with air.

As noted above, another advantage of combusting hydrogen and oxygen is an opportunity to produce steam that can be used beneficially in the process and/or in other unit operations in an alumina plant, such as a Bayer process plant.

The process may further comprise discharging steam from the process and then transferring at least some of the discharged steam to the process, for example to the reaction chamber. The discharged steam transferred to the process may be at least 30%, typically at least 40%, by volume of the volume of the discharged steam. Any heat that is retained in the steam after combustion may therefore be transferred back to the process, for example to the reaction chamber. Transferring at least some of the steam discharged from the process into the reaction chamber helps to reduce the amount of energy required to calcine further amounts of aluminium hydroxide supplied to the reaction chamber. The steam may also contribute to the fluidization and/or transport of aluminium hydroxide and/or alumina through the process, for example through the reaction chamber.

As described above, steam is generated by combustion of hydrogen and oxygen.

Steam may also be generated in the reaction chamber by dehydration of aluminium hydroxide to alumina.

The process may include maintaining the steam at a temperature that is above a condensation temperature of steam under the operating conditions in the process.

Typically, the condensation temperature of the steam is 100° C. at atmospheric pressure.

The process may be carried out at or below atmospheric pressure.

Described in an alternative way, the process may be carried out without placing the reaction chamber under a pressure above that resulting from operating the process as described above, i.e. by supplying hydrogen and oxygen to a reaction chamber and combusting hydrogen and oxygen and generating steam and heat and using the heat to calcine aluminium hydroxide and form alumina and more steam.

More specifically, the process may be carried out without the reaction chamber being constructed as a pressure vessel.

The steam generated in the reaction chamber may act as a transport, i.e. fluidizing, gas in the process, for example for transporting particulate aluminium hydroxide and/or alumina into and/or out of the reaction chamber.

The steam generated in the reaction chamber may act as a heat transfer medium in the process.

The process may further comprise transferring at least some of the steam generated in the reaction chamber (and/or elsewhere in the process) to an alumina production plant for use in the production of alumina in the plant for processes other than calcining aluminium hydroxide to alumina.

For example, at least some of the steam from the process may be used for processes in the plant, such as during digestion of bauxite or the evaporation of Bayer liquor.

The steam used for processes in the plant may be upgraded, for example using a mechanical or thermal vapor recompression device, prior to being used in the other processes.

The hydrogen may have a purity >99%.

The process may comprise connecting an oxygen source to be in fluid communication with the reaction chamber.

The process may comprise connecting a hydrogen source to be in fluid communication with the reaction chamber.

After the process has reached steady state conditions, the process may include discharging a flue gas from the reaction chamber that is at least 85%, typically at least 90, and more typically at least 95% by volume steam.

The term “steady state conditions” is understood herein to mean that the process has completed a start-up phase and is operating at or above a predetermined operating state within control parameters that indicate stable operation to plant operators. The control parameters may be any suitable control parameters selected by plant operators, including temperatures at different points in the process. One example of the control parameters is a temperature that is at or above the condensation temperature of steam.

The flue gas may be 100% steam.

The invention also provides a calcination plant for carrying out the process as set forth above.

The invention also provides a process of starting up a plant for calcining aluminium hydroxide to form alumina, the calcination plant comprising a reaction chamber, the process comprising: a preheating step of heating the reaction chamber until predetermined steady state conditions are achieved and then commencing supply of aluminium hydroxide to the reaction chamber and calcining aluminium hydroxide and forming alumina.

The predetermined steady state conditions may include a temperature that is at or above the condensation temperature of steam.

The preheating step is not confined to combusting hydrogen and oxygen in the reaction chamber.

The preheating step may include combusting any suitable fuel source, including hydrocarbon fuel, in the reaction chamber or externally of the reaction chamber and transferring heat to the reaction chamber.

By way of particular example, steam generated in an alumina production plant may be used to heat the reaction chamber in the preheating step.

The reaction chamber may be heated in the preheating step by transferring at least some of the generated steam into the reaction chamber.

Changing operating conditions after achieving steady-state conditions to combust hydrogen and oxygen in the reaction chamber may include providing a gas feed that increases a proportion of hydrogen over a predefined period of time.

The invention also provides a process of calcining aluminium hydroxide, such as gibbsite, to form alumina (Al₂O₃) for example in an alumina plant, such as a Bayer process plant, the process comprising: combusting hydrogen and oxygen and generating steam and heat, using the heat to calcine aluminium hydroxide and form alumina and more steam, and using the steam generated from the combustion as a transport gas in the process.

The process described in the preceding paragraph may further comprise discharging steam from the process and then transferring at least some of the discharged steam to the process.

The process described may include combusting hydrogen and oxygen and generating steam and heat in a reaction chamber and calcining aluminium hydroxide to form alumina in the reaction chamber.

Alternatively, the process may include combusting hydrogen and oxygen and generating steam and heat in one reaction chamber and transferring the steam and heat to a second reaction chamber and calcining aluminium hydroxide to form alumina in the second reaction chamber.

The process may be applied to an existing calcination plant that operates with natural gas as a fuel source and air as a source of oxygen for combustion of the fuel source.

The existing plant may be suitably modified to use hydrogen as the fuel source and oxygen, typically oxygen only, as the oxygen source for combustion of the fuel source.

In addition, the existing plant may be modified such that steam discharged from the process is transferred to the reaction chamber and acts as a transport gas and, optionally a heat transfer medium.

The invention also provides an apparatus for calcining aluminium hydroxide to form alumina, the apparatus comprising:
a reaction chamber configured to calcine aluminium hydroxide to form alumina;
a source of hydrogen and a source of oxygen for generating heat for calcining aluminium hydroxide in the reaction chamber and generating alumina and steam,
an outlet for alumina, and
an outlet for a flue gas including steam.

The apparatus may comprise a line for supplying steam discharged via the flue gas outlet to the apparatus, for example to the reaction chamber.

The apparatus may include a first reaction chamber for calcining aluminium hydroxide to form alumina and steam and a second reaction chamber for combusting hydrogen and oxygen and generating heat for use in the first reaction chamber.

The two second reaction chamber option may be advantageous in situations whether the calcination process of the invention is retrofitted to an existing calcination plant.

In that event, the existing reaction chamber can continue to function as a chamber for calcining aluminium hydroxide and the second reaction chamber can be purpose-built to combust hydrogen and oxygen and positioned proximate and operatively connected to the existing plant to supply heat to the existing reaction chamber.

The invention also provides a plant for producing alumina, such as a Bayer process plant, the apparatus including the above-described apparatus for calcining aluminium hydroxide to form alumina.

### BRIEF DESCRIPTION OF THE DRAWINGS

Embodiments of the present invention are described further with reference to the accompanying non-limiting Figures of which:

FIG. 1 illustrates an example of a conventional Bayer process flow sheet for producing alumina;

FIG. 2 illustrates an embodiment of an apparatus for calcining aluminium hydroxide in accordance with the invention;

FIG. 3 illustrates another, although not the only other, embodiment of an apparatus for calcining aluminium hydroxide in accordance with the invention;

FIG. 4 illustrates an embodiment of a calcination plant in accordance with the invention that is based on the embodiment of the apparatus for calcining aluminium hydroxide shown in FIG. 3; and

FIG. 5 is XRD results generated in test work on calcination of gibbsite in a steam environment in accordance with the invention.

### DESCRIPTION OF EMBODIMENTS

The following description is in the context of calcining aluminium hydroxide, such as the mineral gibbsite, to form alumina in an alumina plant in the form of a Bayer process plant.

It is noted that the invention is not limited to calcining aluminium hydroxide to form alumina in a Bayer process plant and extends to any plant for producing alumina where calcination is a process step in such a plant.

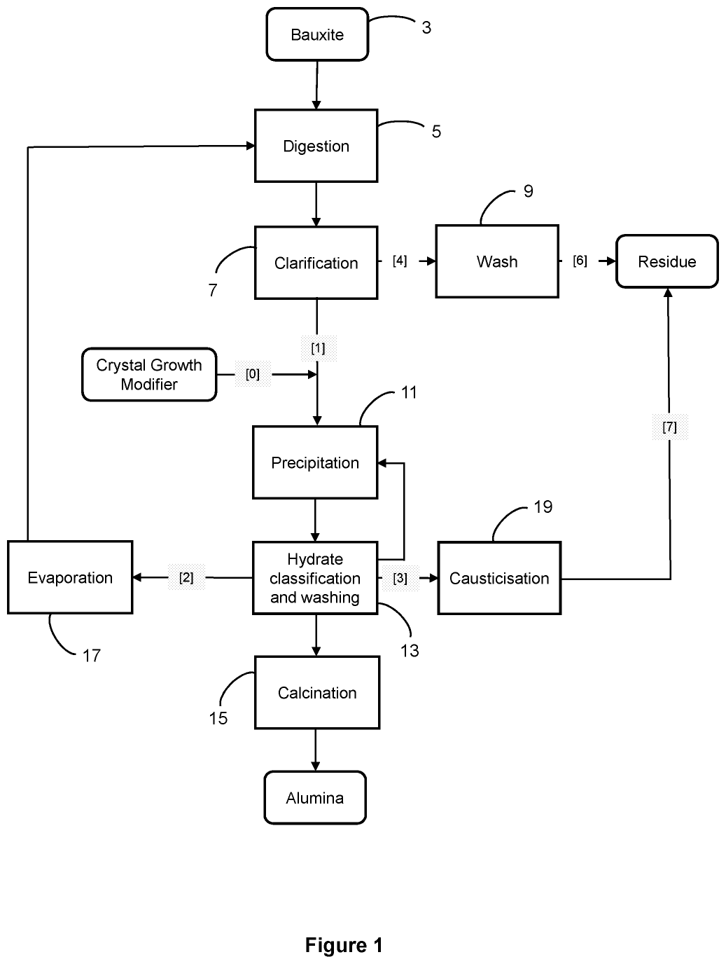

The flow sheet shown in FIG. 1 includes the following process steps:
Digestion of bauxite 3 in a caustic solution.
Clarification (solid/liquid separation of residue from pregnant liquor).
Precipitation of aluminium hydroxide (alumina hydrate).
Return of spent liquor to digestion, for example via an evaporation step 17.
Calcination of aluminium hydroxide to form alumina.

With reference to FIG. 1, bauxite that has been comminuted to a suitable particle size distribution is transferred to a digestion step 5.

The digestion step 5 in the Figure is essentially two steps, namely (a) a pre-disilication step to pre-react any clays or other highly reactive silica containing minerals in the bauxite and start the formation of de-silication product (DSP) and (b) digestion in which a slurry formed in de-silication step (a) is heated to between ˜140° C. and 280° C. depending on the type of bauxite, with alumina and reactive silica dissolving and silica re-precipitates as a DSP that comprises caustic, alumina and silica.

The output of the digestion step 5 is transferred to a clarification step 7 which produces a solid output and a liquid output.

The solid output from the clarification step 7 is transferred as a stream [4] to a washing step 9 and forms a residue 11 that is transferred as a residue stream [6] from the washing step 9.

The liquid output, i.e. a Bayer liquor, more particularly a pregnant Bayer liquor, is transferred as a stream [1] to a precipitation step 11.

In the precipitation step 11, the Bayer liquor is gradually cooled from approximately 80° C. to 65° C. in a cascade of large vessels. The dissolved alumina precipitates as aluminium hydroxide (Al₂O₃.3H₂O).

The output slurry from the precipitation step 11 is transferred to a hydrate classification and washing step 13 and aluminium hydroxide crystals are hot washed.

The outputs of the hydrate classification and washing step 13 are:

(a) spent liquor that is transferred as a stream [2] to an evaporation step 17 and then to the digestion step 5 for use in that step,

(b) washed aluminium hydroxide (Al₂O₃.3H₂O) crystals that are transferred to a calcination step 15 and are calcined in that step to remove water and produce an output alumina (Al₂O₃) product; and

(c) a hydrate wash filtrate that is transferred as a stream [3] to a causticisation step 19.

The causticisation step 19 produces a causticisation stream [7] that becomes part of the residue 11.

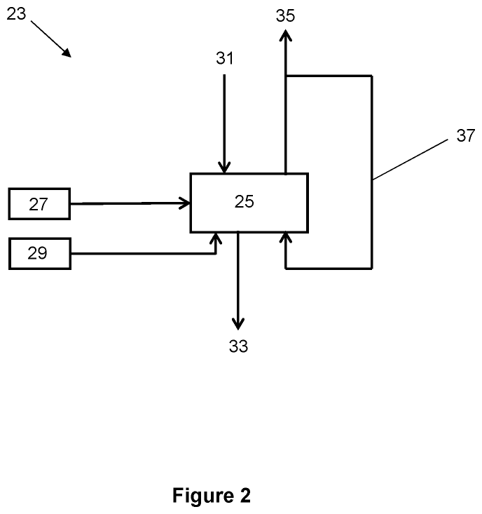

FIG. 2 shows an embodiment of an apparatus to calcine aluminium hydroxide (Al₂O₃.3H₂O) to form alumina (Al₂O₃) in the calcination step 15.

In FIG. 2, the apparatus 23 includes a reaction chamber 25 for calcination reactions to form alumina from aluminium hydroxide.

The reaction chamber 25 may be any suitable chamber for calcination reactions of aluminium hydroxide to alumina.

For example, the reaction chamber 25 can be a rotary kiln or a gas suspension calciner chamber.

The process of the invention does not have to be operated under elevated pressure conditions and, therefore, the reaction chamber 25 does not have to be a pressure vessel.

The reaction chamber 25 is in fluid communication with a hydrogen source 27, an oxygen source 29 (which in this embodiment is oxygen only), and an aluminium hydroxide source 31. The reaction chamber 25 includes inlets and transfer lines for supplying these feed materials to the reaction chamber 25. The reaction chamber 25 includes an alumina discharge line 33 for discharging alumina formed in the reaction chamber 25 from the reaction chamber 25. The reaction chamber 25 also includes an output line 35 for discharging a flue gas generated in the reaction chamber 25 from the reaction chamber 25.

Hydrogen and oxygen from the hydrogen source 27 and the oxygen source 29 respectively are fed into and combusted in the reaction chamber 25 and generate heat and the flue gas. The heat drives water off aluminium hydroxide to form alumina and steam. The flue gas, including steam, is discharged from the reaction chamber 25 via the flue gas line 35.

If the fuel source is not confined to hydrogen and includes other fuels, such as natural gas, (as may be the case in some embodiments of the invention) the flue stream will have steam plus other components such as CO₂. However, when hydrogen is the only fuel source and is combusted in the reaction chamber 25 with only oxygen, steam is the only component in the flue gas line 35. The generation of only steam means that there is no need to separate out other flue gas components, such as CO₂ and N₂, before reusing the steam. Separation of flue gases into individual components is often technically difficult and/or cost prohibitive when looking to isolate steam from flue gas.

In one embodiment, the hydrogen source 27 has a purity >99%. The water driven off during calcination is also present in the flue gas line 35. In this way, there are two sources of steam in apparatus 23, a first source from the combustion of hydrogen and oxygen, and a second source from the dehydration of aluminium hydroxide. In some embodiments the oxygen is provided in stoichiometric excess relative the hydrogen to ensure complete combustion of hydrogen. When oxygen is provided in stoichiometric excess, the flue gas in flue gas supply line may have trace amounts (e.g. <5%) of oxygen. Generally, any excess of oxygen that is used for the combustion of hydrogen is kept to a minimum.

As noted above, by using only hydrogen and only oxygen for combustion to generate heat for the reaction chamber 25, the apparatus 23 does not produce any CO₂ or other carbon-based emissions. If the hydrogen is sourced from renewable sources, the apparatus 23 can significantly reduce its carbon footprint compared to apparatus that rely on natural gas for calcination.

In the embodiment shown in FIG. 2, the flue gas line 35 is split and includes a flue gas transfer line 37 that is fluid communication with the reaction chamber 25. The flue gas transfer line 37 transfers at least some of the flue gas (which typically is at least substantially steam) in the flue gas line 35 to the reaction chamber 25. When heat in flue gas is not captured and instead is vented to the environment, up to 30% of the heat generated in the reaction chamber 25 is lost to the environment. An advantage of transferring at least some of the steam back into the reaction chamber 25 via the flue gas line 35 is that heat that would otherwise be lost to the environment by venting the steam is transferred back into the reaction chamber 25. In this way, the steam can act as a heat transfer medium as heat from the steam can be used elsewhere in the apparatus 23. The use of the flue gas transfer line 37 to return steam back to the reaction chamber 25 can also help to reduce the amount of hydrogen required to maintain a reaction temperature of the reaction chamber 25 because the steam contributes heat to the reaction chamber 25.

It is noted that, in some circumstances, depending on the calcining conditions, there may be small amounts of solids present in the flue gas (i.e. steam) even after the flue gas has passed through a solids filtration unit, such as a bag house and/or electrostatic precipitator. If small amounts of solids are present in the flue gas additional filtration steps can be performed to remove the solids prior to transferring at least some of the steam back into the reaction chamber 25 via the flue gas line 35.

To prevent condensation of steam in the flue gas line 35 and the flue gas transfer line 37, the lines 35, 37 are maintained at a temperature above a condensation temperature of the steam. In an embodiment the condensation temperature of the steam is 100° C. In an embodiment, the steam in the flue gas line 35 is superheated steam i.e. >100° C. In an embodiment, a temperature of the steam is maintained at or above 160° C. Maintaining a temperature of the steam >100° C., such as at about 160° C., can help to prevent condensation of steam. Preventing the condensation of steam can also help to reduce the occurrence of condensed steam causing alumina to “stick” to walls and surfaces of the reaction chamber 25 and surrounding structures. Preventing steam in the flue gas line 35 from condensing helps to prevent a density of the steam from falling below a threshold value that would prevent the steam in the flue gas line 35 from acting as a fluid flow medium such as a transport gas. The latent heat required to break up steam uses a significant amount of energy, so maintaining a temperature of the apparatus 10 above the condensation temperature of steam may help to reduce or eliminate energy intense steam heating steps.

The condensation temperature of steam is dependent upon a pressure of the flue gas line 35. Generally, as a pressure of the flue gas line 35 increases, the temperature at which steam condenses also increases. As noted above, in an embodiment, the apparatus 10 is operated at atmospheric pressure, such as around 1 atm.

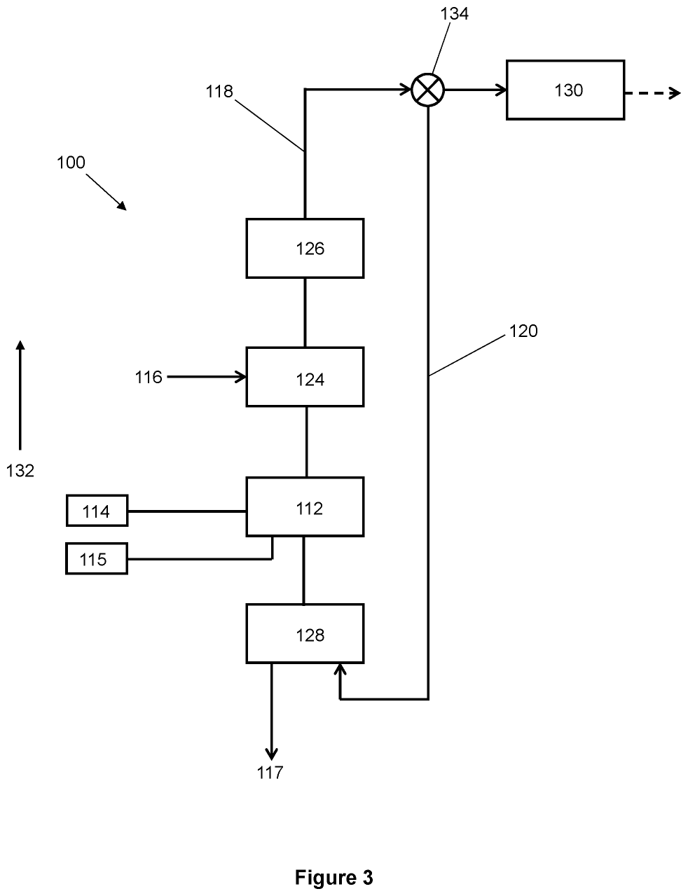

FIG. 3 shows another, although not the only other, example of an apparatus 100 used to calcine aluminium hydroxide to form alumina.

Apparatus 100 is similar to the apparatus 23 of the embodiment of FIG. 2.

In this regard, the apparatus 100 includes a reaction chamber 112, a hydrogen source 114, an oxygen source 115, an aluminium hydroxide source 116, an alumina discharge line 117, a flue gas discharge line 118, and a flue gas transfer line 120 similar to the apparatus 10.

In the embodiment shown in FIG. 3, aluminium hydroxide is supplied from the aluminium hydroxide source 116 to the reaction chamber 112 via a drier 124. The drier 124 removes at least some surface-bound water from the aluminium hydroxide and forms at least some dried aluminium hydroxide upstream of the reaction chamber 112. The partially dried aluminium hydroxide is then calcined to form alumina in the reaction chamber 112.

In the embodiment shown in FIG. 3, following calcination in the reaction chamber 112, the alumina is then transferred to a heat recovery apparatus 128 that recovers heat from the alumina. The heat recovery apparatus 128 may be any suitable form of apparatus. This heat recovery helps to cool the alumina and form cooled alumina and retain heat in the apparatus 100. Alumina discharge line 117 feeds the cooled alumina for further processing, such as packaging and shipping.

In the embodiment shown in FIG. 3, a dust recovery apparatus 126, such as a baghouse, is in fluid communication with the drier 124. Flue gas line 118 extends from the dust recovery apparatus 126.

In the embodiment shown in FIG. 3, flue gas transfer line 120 is in fluid communication with the flue gas line 118 and the heat recovery apparatus 128. At least a portion of the steam in the flue gas stream 118 is transferred to the heat recovery apparatus 128 via the flue gas transfer line 120. The steam transferred to the heat recovery apparatus 128 is used as a transport gas or fluid medium to help transfer aluminium hydroxide and/or alumina through the apparatus 100. Steam that is passed into the heat recovery apparatus 128 travels to the reaction chamber 112, the drier 126 and then through the dust recovery apparatus 126. This direction of steam travel is shown by arrow 132. When aluminium hydroxide is introduced into the drier 124, dust and other fine particulate matter is carried by the steam and transferred to the dust recovery apparatus 126. As the aluminium hydroxide and alumina travels generally in the opposite direction to the flow of steam through the heat recovery apparatus 128, the reaction chamber 112 and the drier 126 (i.e. opposite to direction of steam travel 132), the net flow of aluminium hydroxide and alumina through the apparatus 100 is generally counter-current to the flow of steam. However, it is noted that within the drier 124, reaction chamber 112 and heat recovery apparatus 128 there may be localised co-current flow of the aluminium hydroxide and/or alumina and the steam, but overall there can be a net counter-current flow of the aluminium hydroxide and/or alumina and steam.

The flue gas line 118 is split into two lines. The first line is the above-described flue gas transfer line 120 that provides steam to the heat recovery apparatus 128. The second line provides steam as a steam source 130 for use externally of the apparatus 100.

The steam source 130 can be used to provide steam to other equipment in the Bayer process plant.

For example, the steam source 130 can be used by a digestor during digestion of bauxite, during evaporation of spent Bayer liquid, causticisation to remove impurities in the Bayer process, and in a boiler/steam generator to supplement low pressure steam. In this way, the apparatus 100 can be utilised as a steam generator. The dashed line extending from steam source 130 represents the fact that in some embodiments the steam is not stored or vented but instead is used elsewhere.

The steam source 130 in some embodiments also includes a mechanical vapor recompressor and/or a thermal vapor recompressor to “upgrade” the steam source 130 to higher pressures. For example, mechanical vapor recompression can upgrade the steam from 1 atm to 5 atm, and thermal vapor recompression can upgrade the steam from 5 atm to >10 atm.

To control the relative flows of steam in the flue gas transfer line 120 and the steam source 130, a control valve 134 is provided at the junction of the flue gas transfer line 120 and the steam source 130. The control valve 134 can be manually or autonomously operated to control the relative flows of steam in the flue gas transfer line 120 and the steam source 130. The relative flows of steam in the flue gas transfer line 120 and the steam source 130 may be determined by the operational conditions of the apparatus 100 and the heat requirements for calcination.

Utilising the excess steam generated by the apparatus 100 can help to improve the efficiency of other apparatus and equipment located in and around the Bayer process plant that require the use of steam to operate.

It is noted that although the oxygen source 115 and the hydrogen source 114 are illustrated in FIG. 3 as being connected to and supplying these feed materials directly to the reaction chamber 112, the oxygen source 115 and the hydrogen source 114 only need to be in fluid communication with the reaction chamber 112. Accordingly, the oxygen source 115 and/or the hydrogen source 114 can be connected to an upstream side of the reaction chamber 112 rather than directly to the reaction chamber.

In FIG. 3 the upstream side of the reaction chamber 112 is opposite the direction of arrow 132 i.e. towards the heat recovery apparatus 128. For example, in an embodiment, the oxygen source 115 is connected to the heat recovery apparatus 128.

With such an arrangement, the oxygen being transferred from the oxygen source 115 to the reaction chamber 112 via the heat recovery apparatus 128 can act as a cooling fluid that helps to cool alumina in or near the output line 117. At the same time, oxygen is heated prior to entering the reaching chamber 112. Similarly, the hydrogen source 114 can be connected to the heat recovery apparatus, 128 instead of the oxygen source 115. As a further alternative, both the oxygen source 115 and the hydrogen source 114 are connected to the heat recovery apparatus 128.

When the oxygen source 115 and/or hydrogen source 114 are connected to an upstream side of the reaction chamber 112, the steam from the return line 120 that is transferred to the heat recovery apparatus 128 is used to transfer the oxygen and/or hydrogen gas to the reaction chamber 112 for combustion.

The apparatus 10 and the apparatus 100 are only illustrated in an exemplary form. These are examples of two of a number of possible embodiments.

It can be appreciated that features in FIG. 3, by way of example, such as the reaction chamber 112, the heat recovery apparatus 128 and the drier 126, can be formed from a number of different components and that the reaction chamber 112, the heat recovery apparatus 128 and the drier 126 may have different stages. For example, the reaction chamber 112 can have a primary and secondary heating stage. The heat recovery apparatus 128 can also have a number of cooling stages, such as a series of interconnected cyclones that help to clarify the alumina at different stages.

The embodiment of the apparatus 100 shown in FIG. 3 can be formed as a greenfield plant or by retrofitting an existing calcination apparatus in an alumina plant.

As noted above, one retrofit option includes providing a separate purpose-built reaction chamber to combust hydrogen and oxygen and positioned proximate and operatively connected to the existing calcination apparatus to supply heat to the existing reaction chamber.

With regard to the retrofit option, existing calcination apparatus typically vent flue gas to the atmosphere and have a natural gas supply connected to the reaction chamber. Typically, air is used as an oxygen source and as is transferred to the reaction chamber via heat recovery apparatus, for example 128. Air is also typically used as a transfer fluid. Existing calcination apparatus do not have the flue gas return line 120, the oxygen source 115 and the hydrogen source 114.

In an embodiment, the process of retrofitting a calcination apparatus involves fitting the flue gas transfer line 120 so that a flue stream, for example 118, is in fluid communication with the reaction chamber 112. As illustrated in FIG. 2, the flue gas transfer line 120 is in fluid communication with the reaction chamber 112 via the heat recovery apparatus 128. A hydrogen source, for example 114, and an oxygen source, for example 115, are then connected to the reaction chamber 112.

As the apparatus 100 shown in FIG. 3 requires the use of steam to act as a transport gas or fluid medium to help transfer aluminium hydroxide and/or alumina through the apparatus 100, the apparatus 100 should ideally be at a temperature that is at or above a condensation temperature of steam. The condensation temperature of the steam is around 100° C., although this does depend on an operational pressure of the apparatus 100. In an embodiment, the apparatus 100 is maintained at or above 160° C.

To start up the apparatus 100 shown in FIG. 3 to calcine aluminium hydroxide, the reaction chamber 112 needs to be heated in a preheating step to be at or above a predetermined operating state as a steady-state before commencing supply of aluminium hydroxide to the reaction chamber. The predetermined operating state in an embodiment is a temperature that is at or above the condensation temperature of steam. Heating the reaction chamber 112 above the condensation temperature of steam can be achieved by combusting oxygen and hydrogen in the reaction chamber 112 to generate heat. Once sufficient heat has been generated, the reaction chamber 112 should be above the condensation temperature of steam. Steam generated by the combustion of hydrogen and oxygen can be transferred to the reaction chamber 112, for example via the flue gas return line 120, to heat the reaction chamber 112.

In an embodiment, to prevent flooding of the reaction chamber 112 with condensed steam before the reaction chamber is at or above the condensation temperature of steam, the reaction chamber 112 is typically heated in a start-up phase to a temperature above the condensation temperature of steam by preheating options other than via combustion of pure hydrogen and oxygen in the reaction chamber 112. Once the reaction chamber 112 is heated to a temperature above the condensation temperature of steam, the operation conditions can be changed, and hydrogen and oxygen can then be combusted in the reaction chamber 112 to generate heat and steam. The steam generated in the reaction chamber 112 can then be used to heat other components of the apparatus 100.

In an embodiment, at least the reaction chamber 112 is preheated in the start-up phase with an external heat source, such as steam from another location in the Bayer process plant prior to combustion of hydrogen and oxygen. For example, steam generated during digestion of bauxite could be transferred to the reaction chamber 112 via the steam source 130, return line 120 and heat recovery apparatus 128.

In an embodiment, preheating the reaction chamber 112 in the start-up phase involves combusting natural gas and oxygen in the reaction chamber 112 to generate heat. Once the reaction chamber 112 is at or above the condensation temperature of steam, the operation conditions are changed, and hydrogen is combusted with oxygen in place of natural gas.

The transition from natural gas to hydrogen can be a gradual transition. For example, preheating the reaction chamber 112 may first commence with 100% natural gas and over a period of time or when predefined reaction chamber conditions are met a proportion of the natural gas is replaced with hydrogen until the natural gas has been completely replaced by hydrogen. The natural gas may be completely replaced just prior to the reaction chamber 112 reaching the predetermined operating state is achieved.

Alternatively, preheating the reaction chamber 112 in the start-up phase is commenced by combusting a hydrogen-lean fuel mix that is then transitioned to a hydrogen-rich fuel mix until the predetermined operating state is achieved, at which point the hydrogen-rich fuel mix is swapped with 100% hydrogen.

In an embodiment, the reaction chamber 112 is heated to be at a temperature that is at or above the condensation temperature of steam by heating upstream of the reaction chamber 112, such as at a location of the heat recovery apparatus 128 and allowing the heat to transfer to the reaction chamber 112.

Preheating the reaction chamber 112 in the start-up phase can combine different heating processes. For example, the reaction chamber 112 may be preheated using the external heat source and by combusting oxygen and hydrogen or oxygen and a fuel mix comprising natural gas.

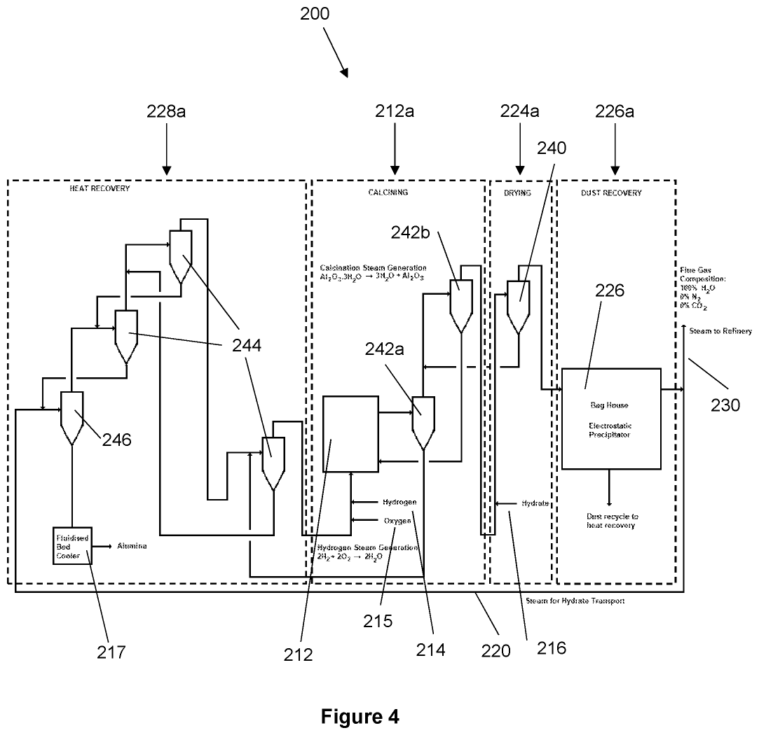

FIG. 4 shows an embodiment of a calcination plant 200 that is based on the apparatus 100 shown in FIG. 3.

The following summary outlines the relationship of the components of the apparatus 100 and the plant 200 in FIG. 4:
The reaction chamber 112 of the apparatus 100 is the calcining section 212a in plant 200.
The drier 124 of the apparatus 100 is the drying section 224a in plant 200.
The heat recovery apparatus 128 in the apparatus 100 is the heat recovery section 228a in plant 200.
The dust recovery apparatus 126 in the apparatus 100 is the dust recovery section 226a in plant 200 which is the form of a baghouse 226.
The aluminium hydroxide source 116 in the apparatus 100 is the hydrate input 216 in plant 200.
The oxygen source 115 and the hydrogen source 114 in the apparatus 100 is, respectively, the oxygen input 215 and hydrogen input 214 in plant 200.
The return line 120 in the apparatus 100 is return steam line 220 in plant 200.
Output line 117 in the apparatus 100 is the alumina outflow 217 in plant 200.

In the plant 200 illustrated in FIG. 4 a direction of flow of steam from the outflow 217 to the baghouse 230 is from left to right. Accordingly, alumina outflow 217 is upstream of the reaction chamber 212 and the baghouse 226 is downstream of the reaction chamber 212.

The drying section 224a has a cyclone 240. Aluminium hydroxide is fed into hydrate input 216 where the above-described flow of steam through the plant 200 carries the aluminium hydrate up to the cyclone 240. At least some and typically most of the surface-bound water is removed from the aluminium hydrate during transport from the input 216 to cyclone 240. The cyclone 240 clarifies the aluminium hydroxide, and dust and other unwanted fine particulate matter is transferred to the baghouse 226.

The clarified aluminium hydroxide is then transferred from cyclone 240 to the calcining section 212a.

The calcining section 212a has cyclones 242a and 242b positioned downstream of the reaction chamber 212. Clarified aluminium hydroxide is fed from cyclone 240 in the drying section 224a to a position upstream of cyclone 242b where steam then transfers the clarified aluminium hydroxide downstream to cyclone 242b for further clarifying aluminium hydroxide. Further clarified aluminium hydroxide (and any formed alumina as a consequence of calcination in the cyclone 242b) is then transferred to the reaction chamber 212. Hydrogen input 214 and oxygen input 215 are immediately upstream of the reaction chamber 212. Hydrogen and oxygen are fed through their respective inputs 214 and 215 into the reaction chamber 212 where they combust to generate heat and steam. The heat calcines aluminium hydroxide to form alumina in the reaction chamber 212. Steam is also generated in the reaction chamber 212 by the dehydration (i.e. calcination) of aluminium hydroxide. Steam is also generated by the evaporation of surface moisture on the aluminium hydroxide in the drying section 224a. For example, surface moisture of aluminium hydroxide is typically about 6% w/w. A majority of the aluminium hydroxide present in the reaction chamber 212 is converted to alumina in the reaction chamber.

The alumina along with any remaining clarified aluminium hydroxide is then transferred from the reaction chamber 212 to cyclone 242a where the remaining clarified aluminium hydroxide is calcined and forms alumina.

The majority, i.e. at least 80%, of the calcination of the clarified aluminium hydroxide generally occurs in the reaction chamber 212.

The steam that is generated in the reaction chamber 212 is transferred through the plant to baghouse 226. It is this transfer of steam from the reaction chamber 212 to the baghouse 226 that helps to at least partially transfer the aluminium hydrate from hydrate input 216 to cyclone 240. Upon exiting the baghouse 226 the steam is divided into the return steam line 220 and steam source 230.

After the alumina has been formed in the reaction chamber 212, it is then transferred to the heat recovery stage 228a. The heat recovery stage 228a has a number of cyclones 244 that clarify and cool the alumina. The alumina passes through the final cyclone 246 before passing through the alumina outflow 217. The return steam line 220 is in fluid communication with the final cyclone 246. The steam in the return steam line 220 fluidise and transport the alumina and aluminium hydroxide in the plant 200.

### EXAMPLES

### Example 1—Modelling Calcination Plant 200

The calcination plant 200 shown in FIG. 4 was modelled using SysCAD to determine the flowrates of the various inputs and outputs used in the plant 200.

In one example, 4.51 t/h of H₂ and 38.2 t/hg of O₂ is supplied to the reaction chamber 212 and 284 t/h of aluminium hydrate is fed into input 216.

The H₂ and O₂ combust to generate 187 t/h of steam.

The value of 187 t/h of steam also includes steam generated in the reaction chamber 212 from dehydration of aluminium hydroxide.

Dehydration of aluminium hydroxide in the drying stage 224a and in the calcining stage 212a prior to the entry of aluminium hydroxide into the reaction chamber 212 means the total amount of steam being generated and transferred from the calcining stage 212a and the drying stage 224a to the baghouse 226 is 287 t/h.

The 284 t/h of aluminium hydrate forms 205 t/h alumina.

114 t/h of steam is transferred through the return steam line 220 to act as the transport gas for the particulate matter e.g. aluminium hydroxide and alumina.

A plant used to calcine aluminium hydroxide to form alumina using natural gas has an energy requirement of about 3 GJ/h, whereas the plant 200 has an energy requirement of about 2.9 GJ/h.

It is noted that the theoretical energy requirement to convert aluminium hydroxide to alumina in plant 200 is about 1.8-2.0 GJ/h, and the difference between the theoretical energy requirement and actual energy requirement is due to energy losses such thermal losses.

However, this calculation does not take into account the fact that the steam generated by the plant 200 can be used elsewhere to reduce the energy requirement of auxiliary equipment in an alumina refinery, so use of the plant 200 may help to improve the overall energy efficiency of an alumina refinery.

Although the detailed description has made reference to calcining aluminium hydroxide to form alumina, the described apparatus and process are applicable to the calcining of other materials such as gypsum. For example, gypsum, selenite and/or basanite can be fed into the reaction chamber 112 to form anhydrite.

### Example 2—Simulating Steam Conditions (Similar to Those of Hydrogen-Oxygen Generated Steam) to Calcine Gibbsite into Alumina

As noted above, the applicant operates natural gas-fired calciners to dehydrate aluminium hydroxide in the form of gibbsite (Al₂O₃.3H₂O) into alumina (Al₂O₃) and the invention was made by the inventors in the context of these calciners.

One difference between the current conditions in the applicant's natural gas-fired calciners and the calcination process and apparatus of the invention is the use of a hydrogen-oxygen flame in accordance with the invention.

The properties of a hydrogen-oxygen flame include a combustion temperature that is significantly higher than the natural gas-air flame temperature (Table 1) and that hydrogen burns with a pale blue flame, leading to minimal heat transfer via radiation.

TABLE 1
Approximate flame temperatures

| | Combustion with air | Combustion with oxygen |
|---|---|---|
| Fuel | (° C.) | (° C.) |
| Natural gas | 1940 | 2760 |
| Hydrogen | 2130 | 2800 |

The dominant heat transfer mechanisms for a hydrogen-oxygen flame are convection and conduction via steam generated via combustion.

These heat transfer mechanisms allow for the hydrogen-oxygen flame to either be contained within the calcination apparatus or externally in a separate reaction chamber (as described above) whereby the steam and heat generated are then transferred to the calcination apparatus, allowing a vast majority of the solids in the calcination apparatus to reach the target temperature.

The risk of high temperature regions (associated with a hydrogen-oxygen flame) in the calcination apparatus is at least substantially eliminated with a separate hydrogen combustion chamber.

Notwithstanding the comments in the preceding paragraph, it is noted that both options of containment of a hydrogen-oxygen flame within the calcination apparatus or externally in a separate reaction chamber are viable options.

Another difference between the current conditions in the applicant's natural gas-fired calciners and the calcination process and apparatus of the invention is the gas composition in the calcination apparatus. If oxygen is combusted with hydrogen, the calciner flue gas would be pure steam, and if oxygen-enriched air is used the flue gas would be a combination of nitrogen and steam.

Some studies have shown the thermal decomposition rate of gibbsite with respect to water vapor concentration was negative, meaning that the water vapor that is produced impedes further gibbsite calcination, whilst there is a counter-view that high water vapor pathways may progress unimpeded via the Boehmite, Gamma, Delta, Theta and ultimately Alpha pathways.

Industrially, gibbsite calcination is conducted in flash calciners and in bubbling or circulating fluidised beds (CFB) reactors.

CFB technology can be scaled up without consequences for product quality, owing to the recirculation of solids in the CFB which results in an even temperature distribution and homogenous product quality also at large capacities and during load changes.

The main components of a CFB calcination process are two preheating stages, a calcining stage and two cooling stages. The entire residence time from when the feed material is fed into the process to the point when the alumina product is discharged is typically approximately 20 minutes. CFB calciners typically operate in a range from 900 to 1000° C., depending on product quality targets. The material is held at the target temperature for 6 minutes.

A primary reason for this Example was to simulate steam conditions (similar to those of hydrogen-oxygen generated steam) in order to calcine gibbsite into alumina, under conditions replicating a typical Circulating Fluid Bed Calciner.

The test work was conducted in a laboratory scale Circulating Fluid Bed reactor.

Methodology

An 85 mm diameter CFB reactor with external electric furnace was used to test calcination of gibbsite in a steam environment.

Prior to each test, the gibbsite was dried at 105° C. to remove any free moisture. The dried solids were then placed in a pressure feeder.

The furnace was heated to target temperature. Low flows of nitrogen were introduced into the system at the following points:
Pressure feeder.
Recirculation line loop seal.
Sample point at bottom of furnace.

These nitrogen flows were required to prevent steam condensing in cooler parts of the system and causing blockages.

The steam was then introduced at the target flow rate, and once the temperature inside the reactor had stabilised, ˜1.5 kg of solids were introduced into the system via the pressure feeder.

Once the solids had reached the target temperature they were held in the system for the required duration prior to sampling the solids in the collection flask at the bottom of the furnace.

Nitrogen was introduced into the flask to help cool the solids in an inert atmosphere and also to displace the steam from the solids before water condensed in the collection flask.

Results

To simulate hydrogen combustion with oxygen in applicant's calciners, the following test condition were used:

TABLE 2
Summary of testwork conditions

| | Gas flowrates | Gas flowrates | |
|---|---|---|---|
| Temperature | (l/min) | (l/min) | Residence time |
| (° C.) | Steam | N₂ | (min) |
| 950 | 25 | 30 | 30 |

Due to the small scale of the equipment and high ambient heat losses, steam condensation occurred in the discharge alumina port, leading to alumina blockages during the test work. For this reason, nitrogen was introduced in increasing amounts as an inert gas to keep the steam from condensing and causing material blockages.

Once the material blockages were resolved with inert gas flow, the gibbsite was calcined with the following outcomes:

X-Ray Diffraction (XRD)

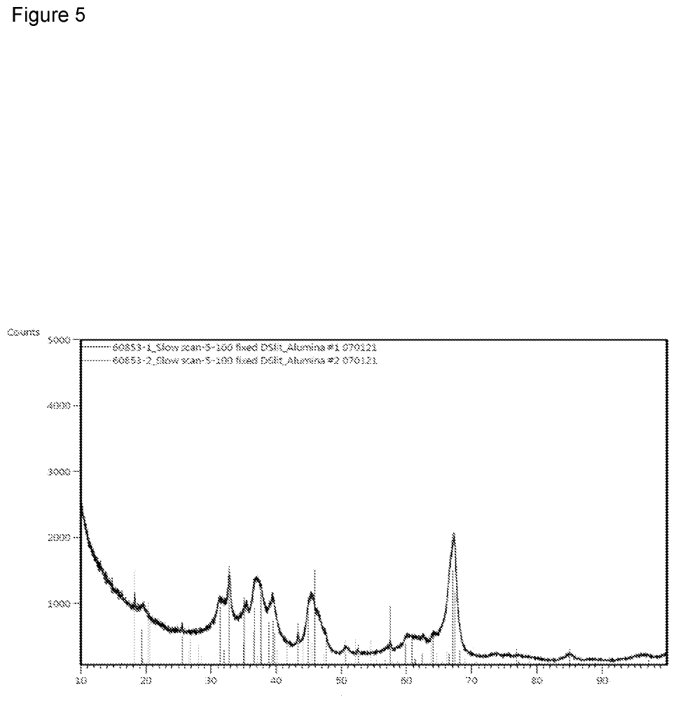

XRD was used to identify the alumina phases formed during the calcination process. Characteristic pattern for the two submitted samples is shown in FIG. 5.

From FIG. 5 it is possible to see the following:

1. Gibbsite was calcined predominantly into gamma and theta alumina phases—this is consistent with the applicant's Smelter Grade Alumina product quality specifications.

2. Gibbsite was marginally calcined into the alpha alumina phase in trace amounts—this is consistent with applicant's Smelter Grade Alumina product quality specifications

Loss on Ignition (LOI)

Loss on ignition was used to determine the amount of gibbsite converted into the alumina phases described above. From this it was possible to see that:

1. Alumina surface moisture was negligible, with a <0.05% remaining water content.

2. Gibbsite conversion to alumina was ˜99.7% complete—this is consistent with applicant's Smelter Grade Alumina product quality specifications.

Discussion

The above results indicate that steam under the conditions produced by a hydrogen-oxygen flame makes it possible to calcine gibbsite into alumina.

Furthermore, the results indicate that the alumina produced is suitable to meet the applicant's Smelter Grade Alumina specification.

Additionally, the formation of major quantities of gamma and theta alumina, support the calcination pathway expected under high vapour conditions:

Gibbsite→(Boehmite)→Gamma Alumina→(Delta Alumina)→Theta Alumina→Alpha Alumina

While the phases in brackets were not directly observed, the technical literature indicates that these phases may have been present during the decomposition reactions.

The above-described use of nitrogen in the test work to manage material handling issues was required due to the small laboratory scale nature of the equipment allowing steam to condense on surfaces exposed to the atmosphere. This is not expected to be an issue on scale-up.

Many modifications may be made to the embodiments of the present invention described above without departing from the spirit and scope of the invention.

By way of example, whilst the embodiments of the present invention described in relation to the Figures combust hydrogen and oxygen and generate steam and heat in a reaction chamber and calcine aluminium hydroxide and form alumina in that reaction chamber, the present invention is not so limited and extends to embodiments that operate with two reaction chambers, one for combusting hydrogen and oxygen and generating steam and heat and a second for calcining aluminium hydroxide and form alumina, with heat and steam being transferred to the second reaction chamber for this purpose.

1. A process of calcining aluminium hydroxide (Al₂O₃.3H₂O) to form alumina (Al₂O₃), comprising:
supplying hydrogen and oxygen to a reaction chamber and combusting the hydrogen and the oxygen and generating steam and heat; and
using the heat to calcine the aluminium hydroxide and form the alumina and more steam.

2. The process defined in claim 1 further comprising transferring at least some of the steam produced in and discharged from the process to the process.

3. The process defined in claim 1 including maintaining the steam at a temperature that is above a condensation temperature of steam.

4. The process defined in claim 1 carried out at atmospheric pressure.

5. The process defined in claim 1 wherein the steam generated in the reaction chamber acts as a transport gas in the process.

6. The process defined in claim 1 wherein the steam generated in the reaction chamber acts as a heat transfer medium in the process.

7. (canceled)

8. The process defined in claim 1 wherein, after the process has reached steady state conditions, the process includes discharging a flue gas from the reaction chamber that is at least 95% by volume steam.

9. (canceled)

10. The process defined in claim 1 wherein the oxygen is supplied as oxygen or oxygen-enriched air and not air and not oxygen-enriched air.

11. (canceled)

12. A process of calcining aluminium hydroxide (Al₂O₃.3H₂O) to form alumina (Al₂O₃), the process comprising: combusting hydrogen and oxygen and generating steam and heat, using the heat to calcine aluminium hydroxide and form alumina and more steam, and using the steam generated from said combustion as a transport gas in the process.

13. The process defined in claim 12 further comprising discharging the steam from the process and then transferring at least some of the discharged steam to the process.

14. The process defined in claim 12 including combusting the hydrogen and the oxygen and generating the steam and the heat in a reaction chamber and calcining the aluminium hydroxide to form the alumina in the reaction chamber.

15. The process defined in claim 12 including combusting the hydrogen and the oxygen and generating the steam and the heat in one reaction chamber and transferring the steam and heat to a second reaction chamber and calcining the aluminium hydroxide to form the alumina in the second reaction chamber.

16. The process defined in claim 12 wherein the oxygen is supplied as oxygen or oxygen-enriched air and not air and not oxygen-enriched air.

17-18. (canceled)

19. A process of starting up a plant for calcining aluminium hydroxide (Al₂O₃.3H₂O) to form alumina (Al₂O₃) in an alumina refinery, the calcination plant comprising a reaction chamber in which oxygen is combusted with a fuel, the process comprising: a preheating step of heating the reaction chamber until predetermined steady state conditions are achieved and then commencing supplying aluminium hydroxide to the reaction chamber and calcining the aluminium hydroxide and forming the alumina.

20. The process defined in claim 19 wherein the preheating step includes combusting hydrogen in the reaction chamber or externally of the reaction chamber and transferring heat to the reaction chamber.

21. (canceled)

22. The process defined in claim 19 wherein the oxygen is supplied as oxygen or oxygen-enriched air and not air and not oxygen-enriched air.

23. (canceled)

24. An apparatus for calcining aluminium hydroxide (Al₂O₃.3H₂O) to form alumina (Al₂O₃), the apparatus comprising: a reaction chamber configured to calcine the aluminium hydroxide to form the alumina; a source of hydrogen and a source of oxygen for generating heat for calcining the aluminium hydroxide in the reaction chamber and generating the alumina and a flue gas including steam, an outlet for the alumina, and an outlet for the flue gas.

25. (canceled)

26. The apparatus defined in claim 24 including a first reaction chamber for calcining the aluminium hydroxide to form the alumina and steam and a second reaction chamber for combusting the hydrogen and the oxygen and generating heat for use in the first reaction chamber.

27. The apparatus defined in claim 24 wherein the source of oxygen is configured to supply oxygen or oxygen-enriched air and not air and not oxygen-enriched air.

28. (canceled)

29. A plant for producing alumina the plant including the apparatus for calcining aluminium hydroxide to form alumina defined in claim 24.
